(19) United States
(12) Patent Application Publication
(10) Pub. No.: US 2010/0088614 A1
(43) Pub. Date: Apr. 8, 2010

(54) JUST-IN-TIME MEDIA DELIVERY SYSTEM

(76) Inventors: FRANK BARBIERI, SANTA MONICA, CA (US); ALAN WESTENBROEK, BARCELONA (ES)

Correspondence Address: DLA PIPER US LLP, 1999 AVENUE OF THE STARS, SUITE 400, LOS ANGELES, CA, 90067-6023, US

(21) Appl. No.: 12/553,060

(22) Filed: Sep. 2, 2009

Related U.S. Application Data
(60) Provisional application No. 61/093,710, filed on Sep. 2, 2008.

(51) Int. Cl. G06F 3/00

(52) U.S. Cl. 715/756

(57) ABSTRACT

The present system is a “just-in-time” approach that locates an online video file when it is requested by an online or mobile application, transfers it from the Web server, transcodes it, and serves it to the mobile handset in the appropriate format, speed, frame-size, and streaming method. Latency is low, with an acceptable balance between user experience and flexibility. Once a video has been transferred to the system, it is cached so it remains available for instant delivery on subsequent requests.

This patent application claims priority to provisional patent application 61/093,710 filed Sep. 2, 2008 and incorporated herein in its entirety.

### BACKGROUND OF THE SYSTEM

There is a large library of video and other media available on the internet today. In addition, more media is being added on a daily basis. Much of the media is stored as Flash or other file formats and stored on Web servers for use by web plug-ins on sites such as YouTube, Break.com, MetaCafe.com, and MySpace Video. These same sites are generating thousands of new files of media content daily. The ability to watch and share media on the internet has become a popular habit and users expect to continue to be able to view media content on other web enabled devices, such as PDA's and mobile phones.

However, most current mobile phones are not capable of displaying these videos, so a user can't just open a web browser on their mobile phones, surf to a video site and watch video. This is due in part to the fact that PCs and mobile phones use different digital video decoding technologies. Even in cases where the phone may have the same digital video decoding technology, large frame-sizes and high frame-rates may exceed the capabilities of mobile devices to display them. For example, current generation Blackberry devices have high resolution screens and faster processors, but it is still not always possible to simply load video content onto the device and expect to play properly or at all. Third party conversion of the content is typically required to modify the frame size and other features just to get the content to play back on the device. Also, the conversion software does not work on the device itself, so a computer must be interposed between the source of the video and playback of the video on the Blackberry. This eliminates easy and rapid sharing of content from one type of device (e.g. pc-based) to a mobile device.

Finally, most mobile phones do not have a fast enough broadband connection to stream these video files in real time, so the viewing experience, even if possible, is compromised.

This means that the millions and millions of videos currently enjoying an explosion of popularity on the desktop Web are not available for the transition to the mobile Web.

One prior art attempt to solve this problem is the use of Flash Lite. While Flash Lite will include the ability to playback streamed Flash videos, it fails to overcome a number of other barriers. For example,

1. It does not address the frame-size, frame-rate, and bandwidth issues.

2. It must be licensed by handset manufacturers and grafted onto the handset's operating system.

3. It is not a “plug-in” that end-users can install, meaning its reach is limited.

Another prior art approach is referred to as a “programmed solution”. In this approach only those videos which have been selected by a media company or carrier to be viewed on mobile can be viewed. As video publishing has now become a massive phenomenon on the web this approach fails to account for the millions of videos a single producer or entity can select. For instance MySpace publishes nearly 50,000 videos a day from users. No programmed solution would allow users to see all those videos.

### BRIEF SUMMARY OF THE SYSTEM

The present system is a “just-in-time” approach that locates an online video file when it is requested by an online or mobile application, transfers it from the Web server, transcodes it, and serves it to the mobile handset in the appropriate format, speed, frame-size, and streaming method. Latency is low, with an acceptable balance between user experience and flexibility. Once a video has been transferred to the system, it is cached so it, remains available for instant delivery on subsequent requests. This allows a site with lots of videos (e.g. YouTube) to instantly mobilize its entire library without the need for any batch or out-of-band conversion. Videos are simply “mobilized” at the moment they are first requested by a user, with no impact to the existing video infrastructure or tech team. There is no need to pre-process every video in the library, only those that are requested. In one implementation, the cache can be governed by a heuristic algorithm that keeps likely to be requested videos in the cache longer than less frequently requested videos.

### BRIEF DESCRIPTION OF THE DRAWINGS

FIG. 1 is a flow diagram illustrating an embodiment of the invention.

FIG. 2 is a flow diagram illustrating the operation of an embodiment of the system.

FIG. 3 is a block diagram illustrating an embodiment of the system.

FIG. 4 is a flow diagram illustrating the operation of an embodiment of the system.

FIG. 5 is an example computer system configuration.

### DETAILED DESCRIPTION OF THE SYSTEM

The system works by placing a request object, like a button or link, on a web page, mobile web page or within a mobile application that describes an online video. The description is collected from metadata associated with that video. A user requests a video that is available for viewing on their mobile phone by clicking the request object. The request may be either from an online or mobile web page or application. At that point, the system does the following:

1. Identifies the location of that video on the video server;

2. Pulls that video from the online source into the JIT System for processing;

3. Processes that video to be viewed by mobile devices;

4. Delivers that video to the mobile device for viewing;

5. Stores a copy of the post processed video should someone in the future request that video.

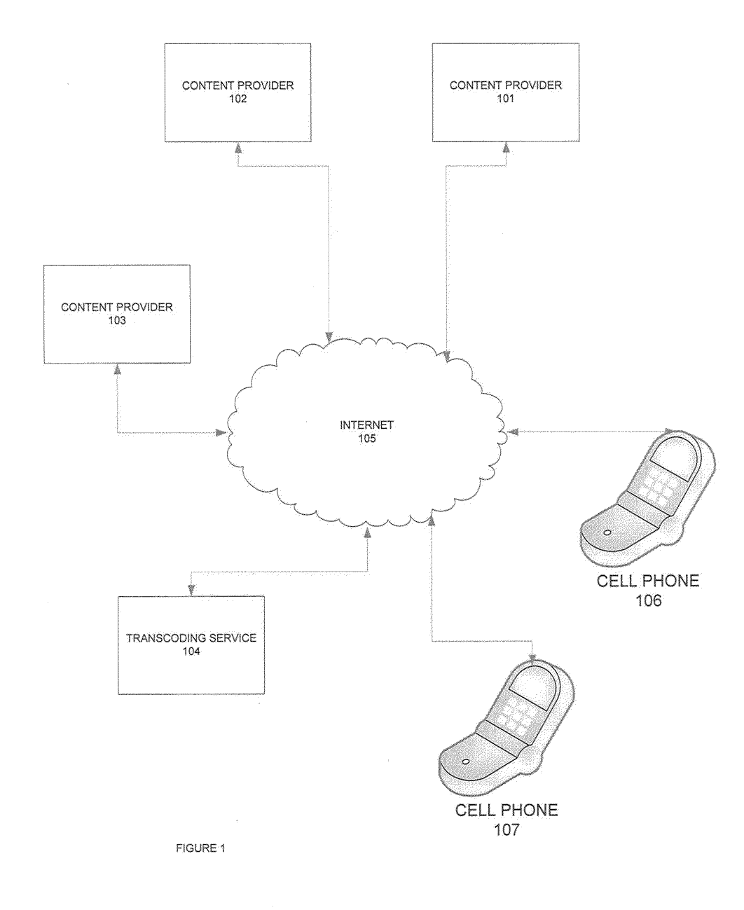

FIG. 1 is a block diagram that illustrates the system. A plurality of media content sources such as content providers 101, 102, and 103 are coupled to a network such as the internet 105. Web enabled cell phones such as phones 106 and 107 are also coupled to the internet 105. A transcoding service 104 can communicate with the content providers and the cell phone users via the internet 105.

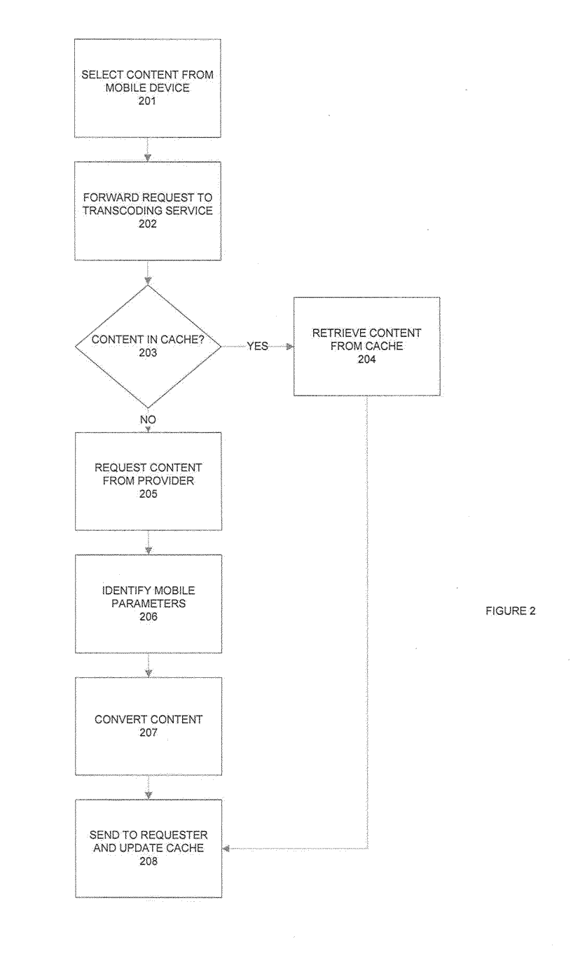

The operation of and embodiment of the system is illustrated in the flow diagram of FIG. 2. At step 201, a cell phone user requests media content from a web site. This is typically done while a user is surfing the web using a web enabled phone. It may also be done by clicking on a link to content in an email message. When surfing the web, content providers may include a link for mobile users that invokes the involvement of the present system.

At step 202 the media request is forwarded through the internet 105 to the transcoding service 104. At step 203 the transcoding service checks its cache to see if it has the content available already. If so, it retrieves the content from cache at step 204. If not, the service 104 requests and retrieves the content from the provider (e.g. providers 101, 102 or 103) at step 205.

At step 206 the service identifies the display parameters of the mobile device that is requesting content. This may be accomplished by reviewing metadata that is associated with the content. In other circumstances, the system may make certain assumptions about the content based on the file type. At step 207 the service 104 converts the content data into a form that can be displayed on the mobile device. At step 208 (and after step 204) the service 104 begins streaming the data to the requester. As noted above, the service does not wait until all of the data is converted before beginning to transmit the data. Instead, the service buffers an amount of data such that there will be time to provide new converted data before the consumption of the previously sent amount is consumed.

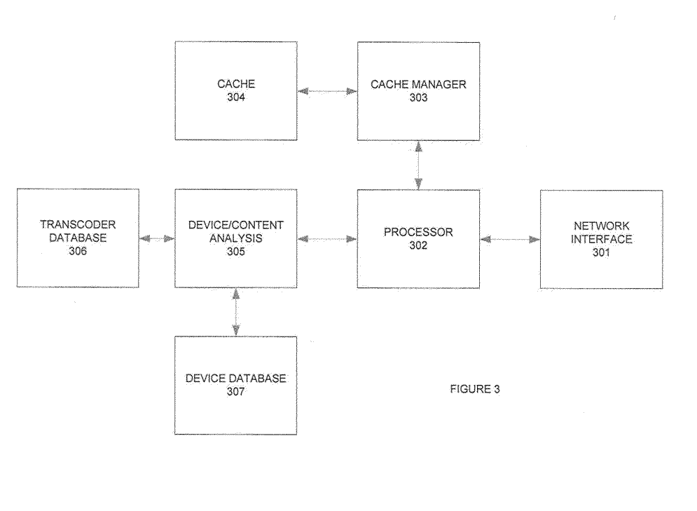

FIG. 3 is a block diagram illustrating an embodiment of the transcoding service of the system. The transcoder service includes a network interface 301 for communicating with the requester and content provider via a network such as the internet. The network interface provides the content request to the processor 302. The processor 302 first sends the request to the cache manager 303 to determine if the content is already available in the cache 304. If not, the content is obtained from the content source. The processor also provides device information and content information to analyzer 305. The analyzer includes a device database 307 that can provide information about which content format can be displayed by the requesting device. The analyzer may also determine the data rate and transfer speed that can be used with the device based on the type of connection the device is using (i.e. wireless, 3G, WiFi, etc.). Based on the parameters of the device, the analyzer also selects the proper transcoder from the transcoder database 306.

Even if the content is available in the cache 304, it may not be in the appropriate format for the requesting device. If not, the appropriate transcoder is determined and applied to the content. The processor 302 also uses the determined connection speed of the requesting device to determine the appropriate just-in-time delivery rate that can be provided to the device while still providing adequate performance.

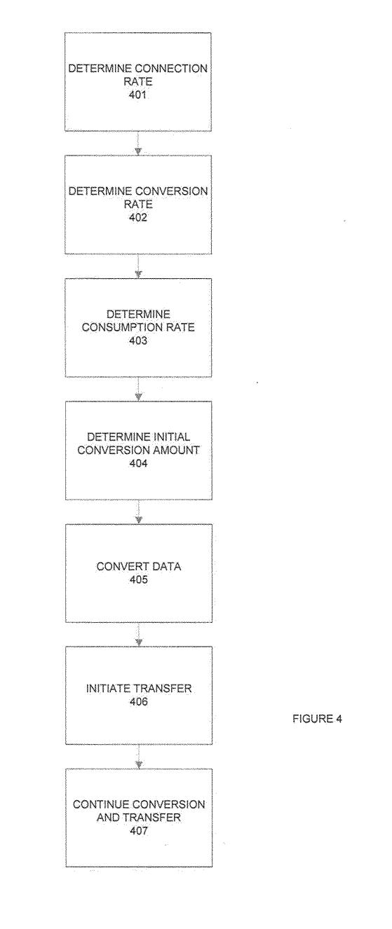

FIG. 4 is a flow diagram illustrating an embodiment of data delivery and scheduling in the system. At step 401 the system determines the connection speed of a requesting device. At step 402 the system determines the conversion rate (based on the transcoder selected) of the content to be provided to the requesting device. At step 403 the system determines the transmission and/or consumption rate of the requesting device. At step 404 the system determines the amount of data to be initially converted prior to initiating delivery of the data to the requesting device. At step 405 the system converts that amount of data. At step 406 the system begins delivery of the converted data to the requesting device. At step 407 the system continues the data conversion process. The purpose is to determine the amount of data to be initially converted and sent to the device so that subsequent conversion and delivery rates are such that there is no delay or pause in the playback of the data at the receiving device.

### Embodiment of Computer Execution Environment (Hardware)

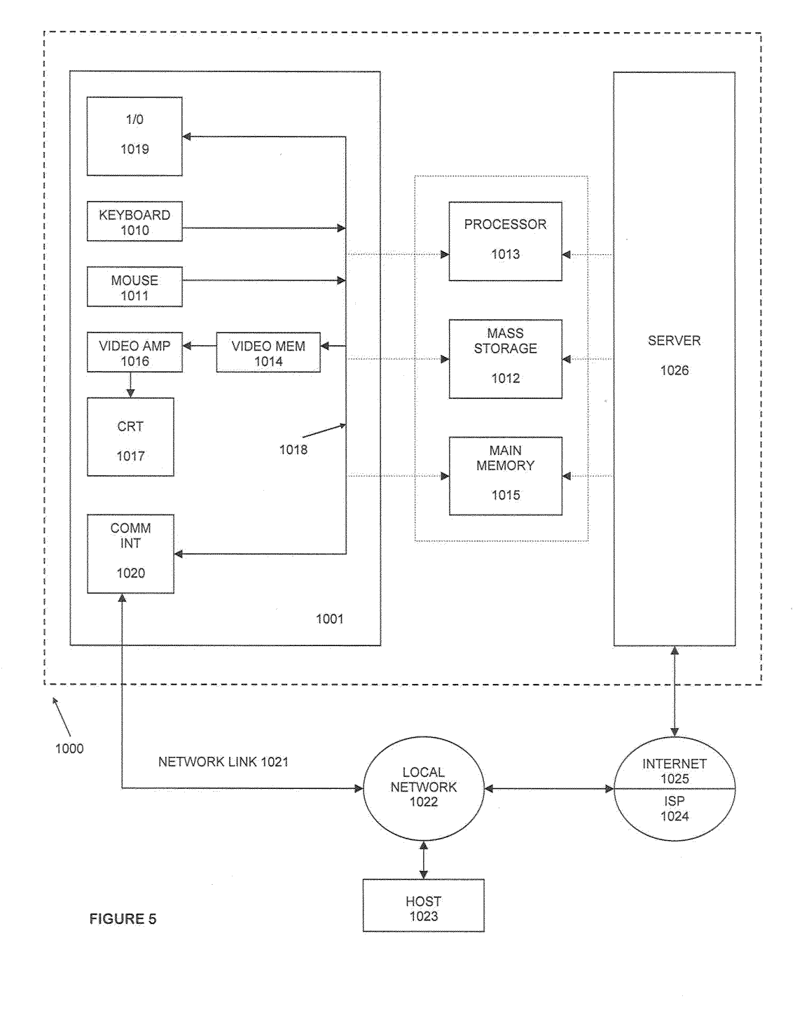

An embodiment of the system can be implemented as computer software in the form of computer readable program code executed in a general purpose computing environment such as environment 500 illustrated in FIG. 5, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 510 and mouse 511 are coupled to a system bus 518. The keyboard and mouse are for introducing user input to the computer system and communicating that user input to central processing unit (CPU 513. Other suitable input devices may be used in addition to, or in place of, the mouse 511 and keyboard 510. I/O (input/output) unit 519 coupled to bi-directional system bus 518 represents such I/O elements as a printer, A/V (audio/video) I/O, etc.

Computer 501 may include a communication interface 520 coupled to bus 518. Communication interface 520 provides a two-way data communication coupling via a network link 521 to a local network 522. For example, if communication interface 520 is an integrated services digital network (ISDN) card or a modem, communication interface 520 provides a data communication connection to the corresponding type of telephone line, which comprises part of network link 521. If communication interface 520 is a local area network (LAN) card, communication interface 520 provides a data communication connection via network link 521 to a compatible LAN. Wireless links are also possible. In any such implementation, communication interface 520 sends and receives electrical, electromagnetic or optical signals which carry digital data streams representing various types of information.

Network link 521 typically provides data communication through one or more networks to other data devices. For example, network link 521 may provide a connection through local network 522 to local server computer 523 or to data equipment operated by ISP 524. ISP 524 in turn provides data communication services through the world wide packet data communication network now commonly referred to as the “Internet” 525. Local network 522 and Internet 525 both use electrical, electromagnetic or optical signals which carry digital data streams. The signals through the various networks and the signals on network link 521 and through communication interface 520, which carry the digital data to and from computer 500, are exemplary forms of carrier waves transporting the information.

Processor 513 may reside wholly on client computer 501 or wholly on server 526 or processor 513 may have its computational power distributed between computer 501 and server 526. Server 526 symbolically is represented in FIG. 5 as one unit, but server 526 can also be distributed between multiple “tiers”. In one embodiment, server 526 comprises a middle and back tier where application logic executes in the middle tier and persistent data is obtained in the back tier. In the case where processor 513 resides wholly on server 526, the results of the computations performed by processor 513 are transmitted to computer 501 via Internet 525, Internet Service Provider (ISP) 524, local network 522 and communication interface 520. In this way, computer 501 is able to display the results of the computation to a user in the form of output.

Computer 501 includes a video memory 514, main memory 515 and mass storage 512, all coupled to bi-directional system bus 518 along with keyboard 510, mouse 511 and processor 513.

As with processor 513, in various computing environments, main memory 515 and mass storage 512, can reside wholly on server 526 or computer 501, or they may be distributed between the two. Examples of systems where processor 513, main memory 515, and mass storage 512 are distributed between computer 501 and server 526 include the thin-client computing architecture developed by Sun Microsystems, Inc., the palm pilot computing device and other personal digital assistants. Internet ready cellular phones and other Internet computing devices, and in platform independent computing environments, such as those which utilize the Java technologies also developed by Sun Microsystems, Inc.

The mass storage 512 may include both fixed and removable media, such as magnetic, optical or magnetic optical storage systems or any other available mass storage technology. Bus 518 may contain, for example, thirty-two address lines for addressing video memory 514 or main memory 515. The system bus 518 also includes, for example, a 32-bit data bus for transferring data between and among the components, such as processor 513, main memory 515, video memory 514 and mass storage 512. Alternatively, multiplex data/address lines may be used instead of separate data and address lines.

In one embodiment of the invention, the processor 513 is a microprocessor such as manufactured by Intel, AMD. Sun, etc. However, any other suitable microprocessor or microcomputer may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the cathode ray tube (CRT) raster monitor 517. Video amplifier 516 is well known in the art and may be implemented by any suitable apparatus. This circuitry converts pixel data stored in video memory 514 to a raster signal suitable for use by monitor 517. Monitor 517 is a type of monitor suitable for displaying graphic images.

Computer 501 can send messages and receive data, including program code, through the network(s), network link 521, and communication interface 520. In the Internet example, remote server computer 526 might transmit a requested code for an application program through Internet 525, ISP 524, local network 522 and communication interface 520. The received code maybe executed by processor 513 as it is received, and/or stored in mass storage 512, or other non-volatile storage for later execution. In this manner, computer 500 may obtain application code in the form of a carrier wave. Alternatively, remote server computer 526 may execute applications using processor 513, and utilize mass storage 512, and/or video memory 515. The results of the execution at server 526 are then transmitted through Internet 525, ISP 524, local network 522 and communication interface 520. In this example, computer 501 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method for providing content to a mobile device comprising:
determining a delivery rate to the mobile device;
determining a conversion rate of the content to a format usable on the mobile device;
determining an initial amount of data to be converted prior to delivering the data to the mobile device:
forwarding the converted content to the mobile device.

2. The method of claim 1 wherein the initial amount is such that subsequent deliver of data can be accomplished without interruption.

3. The method of claim 2 wherein the conversion rate depends on transcoding the data from a first data type to a second data type.

4. The method of claim 3 wherein the data is multimedia data.

5. The method of claim 4 wherein the mobile device is web-enabled.
